(19) United States
(12) Patent Application Publication
(10) Pub. No.: US 2009/0210853 A1
(43) Pub. Date: Aug. 20, 2009

(54) Systems and apparatus for software development

(76) Inventors: Anand Kumar, Andhra Pradesd (IN); Nori Kesav Vithal, Andhra Pradesh (IN); Vemury Chandra Sekhar Prasad, Andhra Pradesh (IN); Reddy Nitin Kunda, Andhra Pradesh (IN)

Correspondence Address: HEDMAN & COSTIGAN P.C., 1185 AVENUE OF THE AMERICAS, NEW YORK, NY, 10036, US

(21) Appl. No.: 12/378,729

(22) Filed: Feb. 19, 2009

(30) Foreign Application Priority Data
Feb. 19, 2008 (IN) 358/MUM/2008

(51) Int. Cl. G06F 9/44

(52) U.S. Cl. 717/101

(57) ABSTRACT

A system for development of a customised software solution, said system comprising feature definition means adapted to define at least one feature for development of said software solution; problem definition means adapted to define at least one problem in relation to said feature for development of said software solution; user value feature rating means adapted to rate user value of said defined feature to obtain a feature value score; user value problem rating means adapted to rate user value of said defined problem to obtain a problem value score; collating means adapted to collate feature value score and problem value score in accordance with pre-defined groups of score relevancy to obtain a perceived score; feature evaluation means adapted to evaluate a developed feature of said software solution to obtain an experienced score; correlation means adapted to correlate said perceived score and said experienced score to obtain a correlation score; and configuration management means adapted to manage features of said software solution in relation to said correlation score to obtain a customised software solution.

### FIELD OF THE SPECIFICATION

This invention relates to systems and apparatus for software Development.

In particular, this invention envisages a system and apparatus for software development which is driven by the needs of potential users and the value that can be delivered to the user.

### BACKGROUND OF THE INVENTION

Software developers develop software containing features catering to the varied needs of software users. Software solutions employ capabilities of computing system as a means to allow users accomplish one or more specific tasks that benefit them in the real world thereby adding value at the time of usage. Software developers typically develop software solutions with/without the required domain expertise and have varied skills that are used in developing the software solution.

Software users, on the other hand, use software solutions with/without the required technical expertise and have different needs with varied importance that is addressed by the solution provided by software developers.

Value to users is the worth of the software solution to the user's problem from the user's point of view at the time of usage. Every user in a market segment has a different notion of value that they wish to experience and look for a software solution that allows them in experiencing this value. Software users appropriate value in the Quality of software and therefore Software development process should create the right value-creating qualities in Software. Lehman's first law of software evolution states that, (Lehman 1974), software must be continually adapted and changed if it is to remain satisfactory in use (sustain value). Ideally, value to users should exist over the lifetime of the solution.

There is a need, for a system and apparatus available to developers to assure and maintain quality in the features of the software solutions they develop, which takes into account and sustains value to users. The responsibility of Software development process is to deliver Software Qualities by Design which means Software development Processes should be designed to build software with quality.

In the existing art, Software Evolution Practice is an approach based on Lehman's law wherein solution developers issue subsequent releases of their products superseding earlier versions, with the latest version being the product of interest, to cope with the increasing/varying needs of users. For realizing such software solutions, developers make changes in the underlying technology or technique or methodology or usage mode or increase the features provided in the software. These sporadic changes need to give meaningful benefits to users else it will degenerate the software solution and lead to diminishing returns in value.

Another approach in the prior art, is Software Product Line practice in which a set of co-existing software solutions are developed and evolved to cater to increasing/varying needs of users across different market segments. Each software solution in the product line is designed to share commonalities in features with other software solutions available in the software product line. Additional features are included to satisfy specific needs of the respective segments. In order to be more worthwhile to the users, it is necessary for the developers to clearly state value from each of the software solutions in the product line and delineate them according to this value.

However in the existing systems, there exists relatively little clarity on two counts:
[i] the extent of value experienced by users by usage of the software solution; and
[ii] on the development process that assures value and the various aspects of the software solution that creates value to users.

### Reasons for Low Clarity in Software Solutions Lie:

[i] in the fact that they employ the capabilities of the computing system as a means to allow users accomplish one or more specific tasks that benefit them in the real world. Software solutions usually adapt best in class technologies to support a huge set of features. These solutions are therefore not able to address concerns whether these set of features in the software solution add value to users, do the technologies adapted add value, how are they adding, how much is being added, what are all the value drivers and value vehicles; and
[ii] that the software development process is the structure imposed on development of a software solution by developers. It involves grappling with rapidly changing technology, making tradeoffs between different users need and performing all the engineering needed to deliver the solution that correlates with these users needs. In essence, developers analyze requirements of the probable users in problem space and map it to definitions in computing space by creating models, scenarios, detailed specifications and functional blocks and adopting standard technological architecture. However, the existing systems are unable to address the concern relating to the kind and extent of value that is being added to users/developers because of use of technology or the way solution is engineered or the way code is constructed. This results in ambiguity, and poor clarity on the extent of value experienced by users using the software solution.

Further there is even lesser clarity on the development process that assures value and the various aspects of the software solution that creates value to users. This in essence is due to the fact that neither users nor developers are able to have clarity on the value creation system that constitutes the development, existence and evolution of the software solution.

### SUMMARY OF THE INVENTION

For the purposes of this specification, a software solution may be defined as a problem solving framework or a task performing framework; said framework being built by a set of pre-defined features and further adapted to obviate a set of problems. Features need to be identified and enhanced and problems need to be identified and solved to obtain a customised software solution; one which is robust and optimum by means of its design itself.

For the purposes of this specification, a Kano model related to a system and methodology for product development and customer satisfaction developed in the 80's by Professor Noriaki Kano which classifies customer preferences into five categories:
Attractive;
One-Dimensional;
Must-Be;
Indifferent; and
Reverse.

This invention proposes a user value driven software development system and apparatus based on value creation system that exists between software developers and users.

According to this invention there is provided a system for development of a customised software solution, said system comprising:
feature definition means adapted to define at least one feature for development of said software solution;
problem definition means adapted to define at least one problem in relation to said feature for development of said software solution;
user value feature rating means adapted to rate user value of said defined feature to obtain a feature value score;
user value problem rating means adapted to rate user value of said defined problem to obtain a problem value score;
collating means adapted to collate feature value score and problem value score in accordance with pre-defined groups of score relevancy to obtain a perceived score;
feature evaluation means adapted to evaluate a developed feature of said software solution to obtain an experienced score;
correlation means adapted to correlate said perceived score and said experienced score to obtain a correlation score; and
configuration management means adapted to manage features of said software solution in relation to said correlation score to obtain a customised software solution.

Typically, said feature definition means includes a classification means for classifying features of said software solution.

Preferably, said classification means is based on Kano model.

Typically, said feature definition means includes a grouping means for grouping features of said software solution in a pre-defined manner.

Preferably, said grouping means is based on Kano model.

In accordance with this invention the solution provided provides certainty in the delivered quality characteristics of features by design and not by testing.

Further in accordance with this invention a framework based on value co-creation by cluster of developers and users is envisaged which accumulates value at different levels of understanding of the development process thereby bringing clarity and exemplifying value to users.

Particularly in accordance with this invention software developers adapt technologies and create products solving existing problems of users or explore new avenues searching for value. The shorter the gap between users' problem and developers' solutions, the larger is the accumulated value. In order to reduce the ambiguity in identifying and analyzing value of a software solution to its potential users and all stakeholders, it is proposed in accordance with this invention that software solutions be designed based on value accumulated at various levels. Software solutions help users accomplish tasks in real world thereby benefiting them. Such benefits can be tangible or intangible. Benefits that are tangible can be quantified and contribute directly to value perceived by users. Intangible benefits are subjective in nature, left to user's discretion and vary between users. One way to increase value to users is by reducing subjectivity in intangible benefits thereby making them tangible. To achieve this, a better idea of how software solution is realized is necessary so that value to all stakeholders can be identified, created, analyzed and improved. Software solutions have features that exploit the capabilities of the system to allow users perform tasks. These features address users' needs and serve as the first source of value. While, un-met and un-articulated needs pave way for new features and serve as source for future value, unused and evolving features pave way for more value to users during usage. The excellence of features available in a software solution corresponds to quality characteristics of the solution. This excellence stated as quality characteristics serve as a differentiator between various software solutions providing similar features. Further, such an excellence serves as an additional source of value. While it is difficult to articulate value of a software solution, it is relatively easier to state what its quality characteristics are. In any form of production, every process step leads to product quality which implies that quality can be controlled during production. Then, Software development reduces to adopting processes and structures to realize features with desired quality characteristics.

To achieve this,
1. Every software developer playing a role in the software process should ensure acceptable outcomes.
2. Every developer is responsible for producing acceptable software quality through the work in the assigned process step.
3. There exists constraints in each step due to software process quality requirements and software quality requirements.
4. Every developer justifies that their responsibility is met by satisfying checklists and by explicit claims that their work is in conformance.

Typically, said system includes a segregation and level formation, with each levels evolving in a synchronized manner, adapted to segregate said perceived score in relation to score relevancy and form slabs of score relevancy in a pre-defined manner. Each level includes pre-defined parameters relating to different perspectives in understanding software. Each level configuration, if semantically motivated, explains how a problem is addressed. The different levels allow to look at different levels of details, and Commutation between levels ensures that desired properties of higher levels are preserved in lower levels

Typically, said Software development system and Process is stratified according to the levels of understanding and quality is interpreted according to these levels and built into software in the associated strata. Software is realized by commutation between the levels of understanding in the course of which desired qualities of solution is introduced. As the development process moves from one level to the next greater detail is achieved, which contributes to increase in granularity of structural understanding.

Typically, said configuration management means comprises:
configuration feature identification means adapted to identify said features of said software solution in relation to said feature value score;
configuration feature control means adapted to control and change said identified features of said software solution;
configuration feature status recording means adapted to maintain a record of said changes to said features performed by said configuration feature control means and provide a feed back to said configuration feature control means in relation to said obtained relevancy score; and
configuration securing means adapted to secure changes performed by said configuration feature control means.

Typically, said configuration management means comprises:
configuration problem identification means adapted to identify said problems of said software solution in relation to said problem value score;
configuration problem solving means adapted to solve said identified problems of said software solution;
configuration status recording means adapted to maintain a record of said solutions performed by said configuration problem solving means and provide a feed back to said configuration problem solving means in relation to said obtained relevancy score; and
configuration securing means adapted to secure changes performed by said configuration problem solving means.

### BRIEF DESCRIPTION OF THE ACCOMPANYING DRAWINGS

The invention will now be described with particular reference to the accompanying drawings in which:

FIG. 1 of the accompanying drawings, illustrates a Value Creation System that exists between software developers and users;

FIG. 2 shows the top down of value co creation in accordance with this invention;

FIG. 3 illustrates the developed Software as Configurations of Qualities in Configuration Items; and

FIG. 4 illustrates the Creation of Products of a Product Line based on Configuration Items and their interconnections.

### DETAILED DESCRIPTION OF THE ACCOMPANYING DRAWINGS

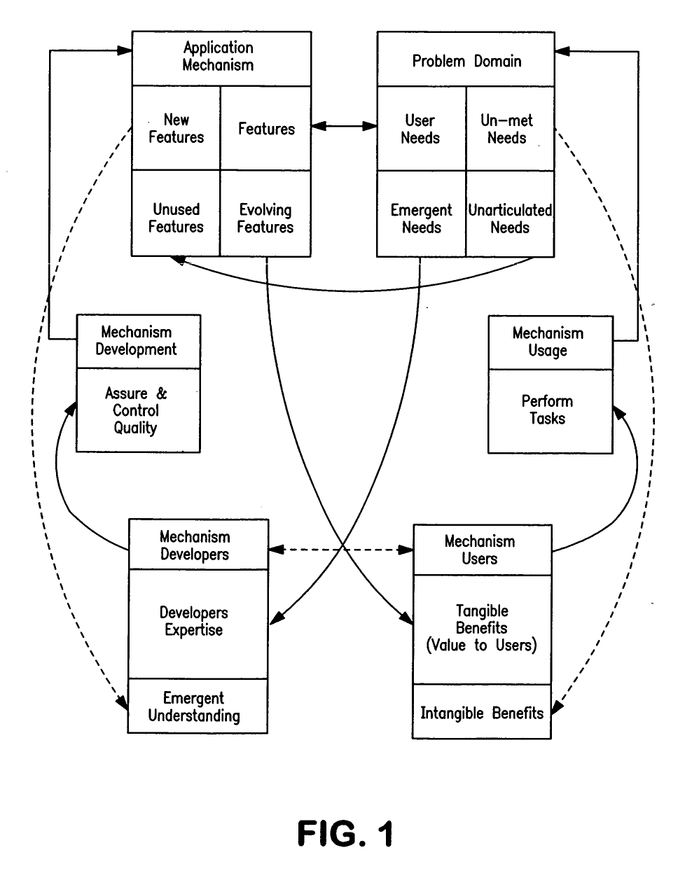

Referring to FIG. 1 of the accompanying drawings, it is seen that Software solutions have features that exhibit quality characteristics. Every user has his/her own notion of value, its importance and features that help them experience value. Developers need to have this understanding of user's priorities to increase value.

This invention includes a Kano model for articulating features and classifying them as essential; performance specific and exciting in nature.

According to this invention, there is provided a system for development of a customised software solution, said system comprising:
feature definition means adapted to define at least one feature for development of said software solution;
problem definition means adapted to define at least one problem in relation to said feature for development of said software solution;
user value feature rating means adapted to rate user value of said defined feature to obtain a feature value score;
user value problem rating means adapted to rate user value of said defined problem to obtain a problem value score;
collating means adapted to collate feature value score and problem value score in accordance with pre-defined groups of score relevancy to obtain a perceived score;
feature evaluation means adapted to evaluate a developed feature of said software solution to obtain an experienced score;
correlation means adapted to correlate said perceived score and said experienced score to obtain a correlation score; and
configuration management means adapted to manage features of said software solution in relation to said correlation score to obtain a customised software solution.

Quality characteristics for these features are identified and grouped and are addressed to help users attain intended value. Typically, inputs are received for software development from architects, engineers, programmers, and the like, and these inputs along with feedback is used to realize the features of the software solution with the desired quality characteristics.

Typically, users provide inputs that correlate to features and corresponding quality characteristics, architects provide inputs directed to functionalities for addressing quality characteristics of the solution; the engineers' inputs are directed to addressing architecture quality characteristics of the solution; the programmers provide functionalities for addressing the engineering quality characteristics of the solution and so on. In essence inputs and feedbacks are received from all stake holders that contribute to value accumulated by users of software solution. These inputs and feed backs are classified and grouped in different levels in a framework that separates levels of understanding of features based on different knowledge domains involved and value accumulated at each of these levels.

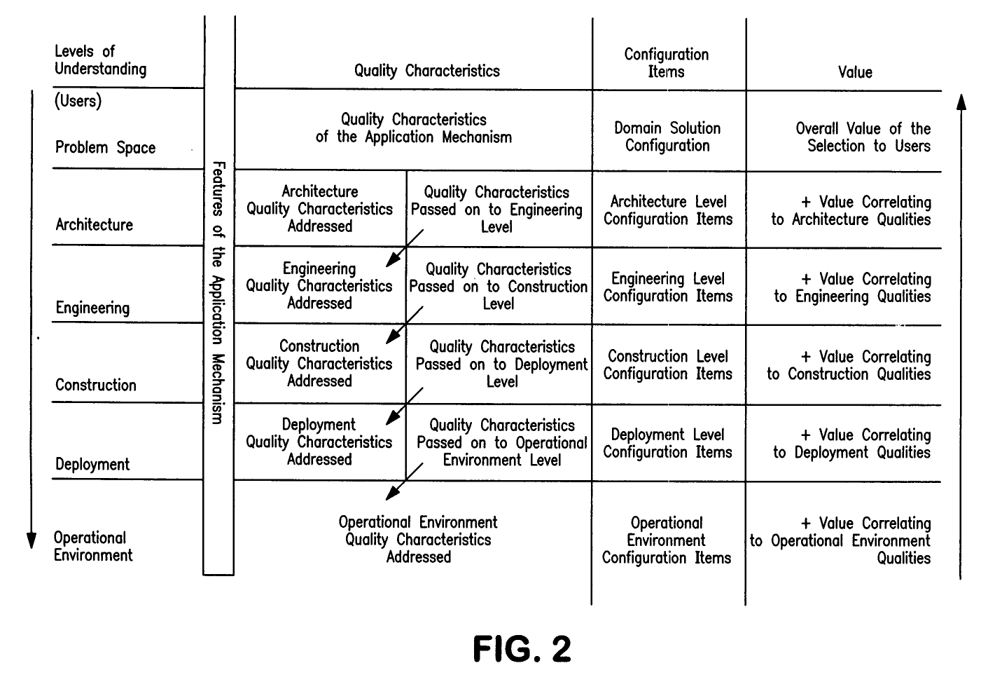

In accordance with a preferred embodiment of the invention, at each level w a subset of features are addressed along with its desired quality characteristics. If certain quality characteristics have a bearing on value to users are difficult to handle/address then those quality characteristics can be passed on and addressed at subsequent levels. In order to exemplify value, the system in accordance with this invention envisages a top down approach, as shown in FIG. 2, where software solution architecture establishes qualities that relate to problem domain and passes on qualities related to computing technologies and structures, engineering ensures that the computing qualities referred to above are satisfied, construction focuses on effective use of implementation technologies, and deployment establishes a match between the solution and its operational environment. In order to successfully adopt the system in accordance with this invention, it is essential that the demarcation of what qualities needs to be addressed at what level needs to be first analyzed.

The system involves a synergistic process in which the whole is more than the sum of its parts. The system to build values into the process is to disaggregate the features/benefits to users from the sum to its components in terms of qualities as parts. These parts are then used to add value to users typically by configuration management to ensure that the final solution assures the quality in the deliverable.

Typically in accordance with this invention a software solution is treated as a configuration of features and desired qualities, with intended benefits for users on usage, and the development of the software involves various tools which identify, define, control change, and verify completeness and correctness of configuration items. The software development system in accordance with this invention is a two step process:
[i] disaggregating features/benefits of the solution as parts; and
[ii] realizing them at different levels in the framework of understanding.

Configuration items are parts that need to be addressed at these levels of understanding. The, development of the software the involves identifying, stating and addressing necessary configurations of configuration items at the appropriate level.

Once the configuration is realized the development takes place in accordance with this invention synergistically with synchronization, coordination and cooperation, ensuring not only value for all involved but also ever increasing solution value.

As illustrated in FIG. 2 of the accompanying drawings, domain solution configuration caters to features/benefits of the software solution, architecture configuration correlates to architecture qualities, engineering configuration correlates to engineering qualities, construction configuration correlates to construction qualities.

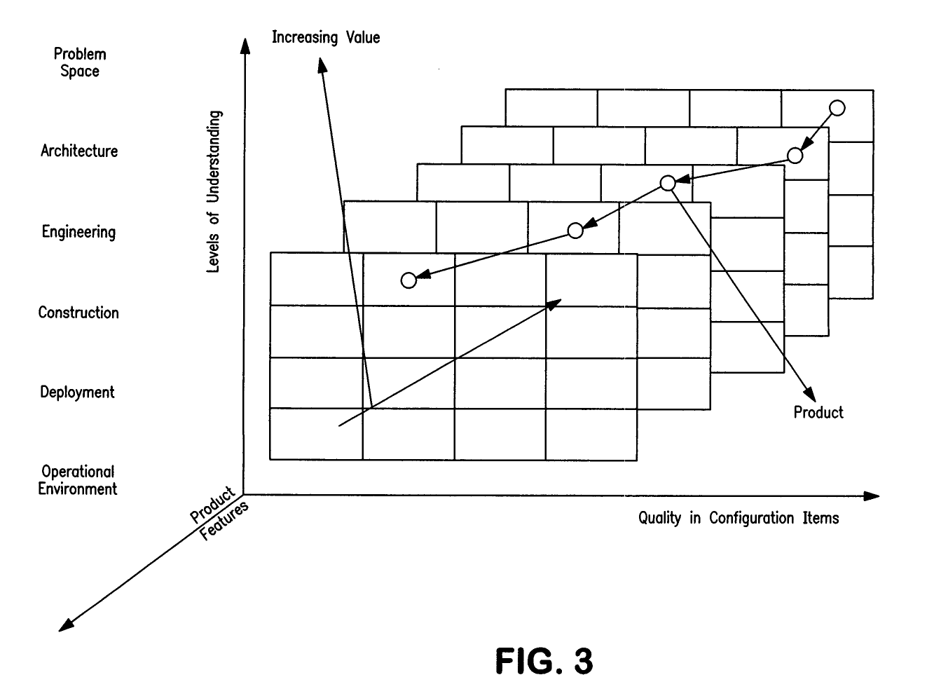

As shown in FIG. 3 of the accompanying drawings, the delivered software product is a string that threads through and aggregates different configurations of configuration items at different levels of understanding. In order to successfully adopt this model, it is essential that the level at which specific qualities are to addressed are carefully demarcated.

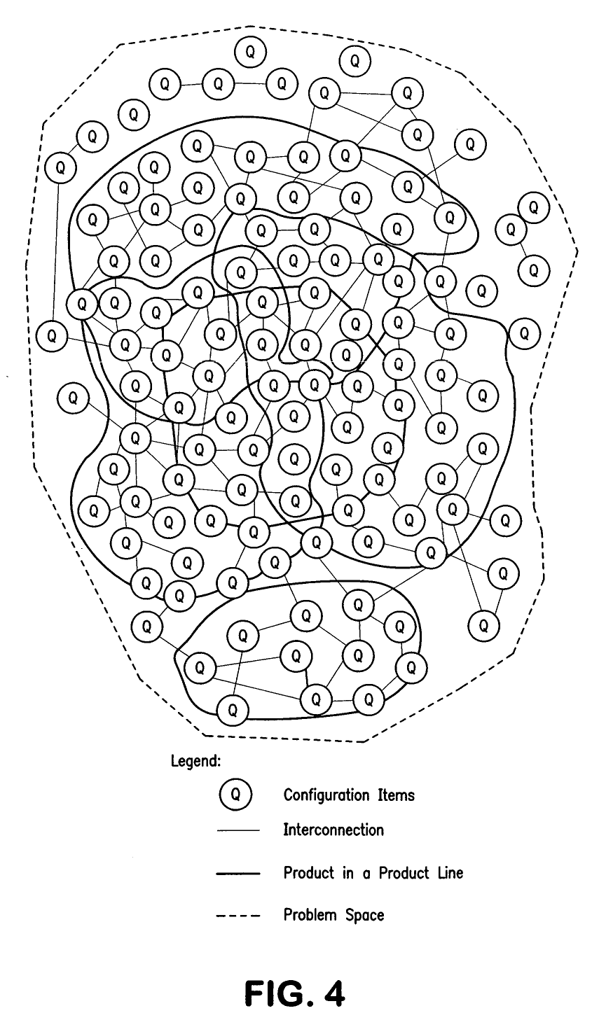

A software product lines is perceived as a set of configurations comprising common needs/quality characteristics and customized with specific needs/quality characteristics of user segments. The system in accordance with this invention simplifies/standardizes the structured design of product lines into creation of different configurations of configuration items with each configuration set resulting in the realization of a product in the product line. Now, capability evolution of existing product in product lines transforms into reconfiguration of the product with a new set of configuration items. Different products in software product line can then be identified based on understanding of differences in configuration items that they address and varied benefits that they provide to users. There can be differences in functionality, which leads to a suite, or differences in features and product qualities, which leads to a line-up of different models of the same product. FIG. 4 of the accompanying drawings is an illustration of the use of this invention.

According to an embodiment of this invention, said configuration management means comprises:
configuration feature identification means adapted to identify said features of said software solution in relation to said feature value score;
configuration feature control means adapted to control and change said identified features of said software solution;
configuration feature status recording means adapted to maintain a record of said changes to said features performed by said configuration feature control means and provide a feed back to said configuration feature control means in relation to said obtained relevancy score; and
configuration securing means adapted to secure changes performed by said configuration feature control means.

According to another embodiment of this invention, said configuration management means comprises:
configuration problem identification means adapted to identify said problems of said software solution in relation to said problem value score;
configuration problem solving means adapted to solve said identified problems of said software solution;
configuration status recording means adapted to maintain a record of said solutions performed by said configuration problem solving means and provide a feed back to said configuration problem solving means in relation to said obtained relevancy score; and
configuration securing means adapted to secure changes performed by said configuration problem solving means.

It is seen that there maybe overlap of desired benefits and this corresponds to overlaps in configuration items of products that need to be developed. There may also be some configuration items that are not part of any solution and these serve as future segments of interest. The software evolution in accordance with this invention, adopts an evolutionist approach for designing software product lines. The configuration items can be componentized as building blocks of products and are made available in the gene pool. Then, a collection of products in a product line are reduced to structured/configured binding of various configuration items from the gene pool. Evolution in accordance with this invention involves a process of careful mutation and careful and not random substitution of configuration items from the gene pool.

The advantages of the system and apparatus in accordance with this invention is that the value driven system assures certainty of quality being delivered by design and not by testing.

While considerable emphasis has been placed herein on the particular features of the present invention, the improvisation with regards to it, and the specific steps of the preferred process, it will be appreciated that various modifications can be made, many steps can be taken and that many changes can be made in the preferred steps without departing from the principles of the invention. These and other modifications in the nature of the invention or the preferred steps of the invention will be apparent to those skilled in the art from the disclosure herein, whereby it is to be distinctly understood that the foregoing descriptive matter is to be interpreted merely as illustrative of the invention and not as a limitation.

1. A system for development of a customised software solution, said system comprising:
feature definition means adapted to define at least one feature for development of said software solution;
problem definition means adapted to define at least one problem in relation to said feature for development of said software solution;
user value feature rating means adapted to rate user value of said defined feature to obtain a feature value score;
user value problem rating means adapted to rate user value of said defined problem to obtain a problem value score;
collating means adapted to collate feature value score and problem value score in accordance with pre-defined groups of score relevancy to obtain a perceived score;
feature evaluation means adapted to evaluate a developed feature of said software solution to obtain an experienced score;
correlation means adapted to correlate said perceived score and said experienced score to obtain a correlation score; and
configuration management means adapted to manage features of said software solution in relation to said correlation score to obtain a customised software solution.

2. A system as claimed in claim 1 wherein, said feature definition means includes a classification means for classifying features of said software solution.

3. A system as claimed in claim 1 wherein, said feature definition means includes a Kano model based classification means for classifying features of said software solution.

4. A system as claimed in claim 1 wherein, said feature definition means includes a grouping means for grouping features of said software solution in a pre-defined manner.

5. A system as claimed in claim 1 wherein, said feature definition means includes a Kano model based grouping means for grouping features of said software solution in a pre-defined manner.

6. A system as claimed in claim 1 wherein, said system includes a segregation and level formation means, with each level evolving in a synchronized manner and adapted to segregate said perceived score in relation to score relevancy and form levels of score relevancy in a pre-defined manner.

7. A system as claimed in claim 1 wherein, said configuration management means comprises:
configuration feature identification means adapted to identify said features of said software solution in relation to said feature value score;
configuration feature control means adapted to control and change said identified features of said software solution;
configuration feature status recording means adapted to maintain a record of said changes to said features performed by said configuration feature control means and provide a feed back to said configuration feature control means in relation to said obtained relevancy score; and
configuration securing means adapted to secure changes performed by said configuration feature control means.

8. A system as claimed in claim 1 wherein, said configuration management means comprises:
configuration problem identification means adapted to identify said problems of said software solution in relation to said problem value score;
configuration problem solving means adapted to solve said identified problems of said software solution;
configuration status recording means adapted to maintain a record of said solutions performed by said configuration problem solving means and provide a feed back to said configuration problem solving means in relation to said obtained relevancy score; and
configuration securing means adapted to secure changes performed by said configuration problem solving means.
